(19) United States
(12) Patent Application Publication
(10) Pub. No.: US 2021/0196563 A1
(43) Pub. Date: Jul. 1, 2021

(54) Releasable battery assembly of massage gun

(71) Applicant: SiChang Sheng, Changzhou (CN)

(72) Inventor: SiChang Sheng, Changzhou (CN)

(21) Appl. No.: 17/199,446

(22) Filed: Mar. 12, 2021

(51) Int. Cl. A61H 23/02; A61H 23/00; H01M 50/247; H01M 50/264

(52) U.S. Cl. CPC A61H 23/02; A61H 23/006; H01M 50/247; H01M 2220/30; A61H 2201/0153; A61H 2201/0107; H01M 50/264

(57) ABSTRACT

A percussive massage gun includes a handle; a battery assembly including an upper shell, a lever, a tab formed with the lever, two first biasing members, a battery, a second biasing member biased between the tab and the battery, and a lower shell; and a connection member formed with the handle and releasably secured to the battery assembly. The battery is releasably fastened in the upper and lower shells. The upper shell includes a slot with the lever disposed through, and a through hole. The lever includes two pegs. The first biasing members are put on the pegs to push the lever through the through hole. The lower shell includes two bossed holes for complementarily receiving the pegs.

### BACKGROUND OF THE INVENTION

### 1. Field of the Invention

The invention relates to therapeutic devices and more particularly to a percussive massage gun having a releasable battery assembly with improved safety and being convenient in use.

### 2. Description of Related Art

Percussive massage is a rapid, percussive tapping, slapping and cupping of an area of the human body. Percussive massage is used to strengthen deep-tissue muscles. Percussive massage increases local blood circulation and can even help tone muscle areas. Percussive massage may be applied by electromechanical percussive massage devices which may include an electric motor for driving a reciprocating piston within a cylinder. A variety of percussive heads may be attached to the piston to provide different percussive effects on selected areas of the body. Conventional personal massage devices often have at least one rechargeable battery disposed in the handle and this arrangement is not safe. Further, the battery may be quickly consumed after several times of use and is required to charge which is cumbersome.

Thus, the need for improvement still exists.

### SUMMARY OF THE INVENTION

The invention has been made in an effort to solve the problems of the conventional art by providing a releasable battery assembly of a percussive massage gun having novel and nonobvious characteristics.

To achieve above and other objects of the invention, the invention provides a percussive massage gun comprising a battery assembly including an upper shell, a lever, a tab formed with the lever, two first biasing members, a battery, a second biasing member biased between the tab and the battery, and a lower shell; and a connection member integrally formed with the handle and releasably secured to the battery assembly; wherein the battery is releasably fastened in the upper and lower shells; the upper shell includes a slot with the lever disposed through, and a through hole; the lever includes two pegs; the first biasing members are put on the pegs to push the lever through the through hole to be positioned; and the lower shell includes two bossed holes for complementarily receiving the pegs.

The percussive massage gun of the invention has the following advantageous effects in comparison with the prior art: The battery assembly can be secured to the handle prior to use. After the battery has been consumed, the battery assembly can be released prior to releasing the battery with a fully charged battery. It is reliable. The battery assembly is not disposed in the handle, thereby increasing safety in use.

The above and other objects, features and advantages of the invention will become apparent from the following detailed description taken with the accompanying drawings.

### BRIEF DESCRIPTION OF THE DRAWINGS

FIG. 1 is a perspective view of a percussive massage gun according to the invention;

FIG. 2 is a perspective view of a first battery assembly according to a first preferred embodiment of the invention;

FIG. 3 is an exploded view of the first battery assembly;

FIG. 4 is a perspective view of a second battery assembly according to a second preferred embodiment of the invention;

FIG. 5 is a perspective view of the upper shell of the second battery assembly viewed from the bottom;

FIG. 6 is a perspective view of the lever of the second battery assembly after the upper shell of FIG. 5 has been removed;

FIG. 7 is an exploded view of the second battery assembly;

FIG. 8 is a perspective view of a third battery assembly according to a first preferred embodiment of the invention;

FIG. 9 is a perspective view of the upper shell of the third battery assembly viewed from the bottom;

FIG. 10 is an exploded view of the third battery assembly; and

FIG. 11 is a side elevation schematically depicting the handle, the connection member and the battery assembly.

### DETAILED DESCRIPTION OF THE INVENTION

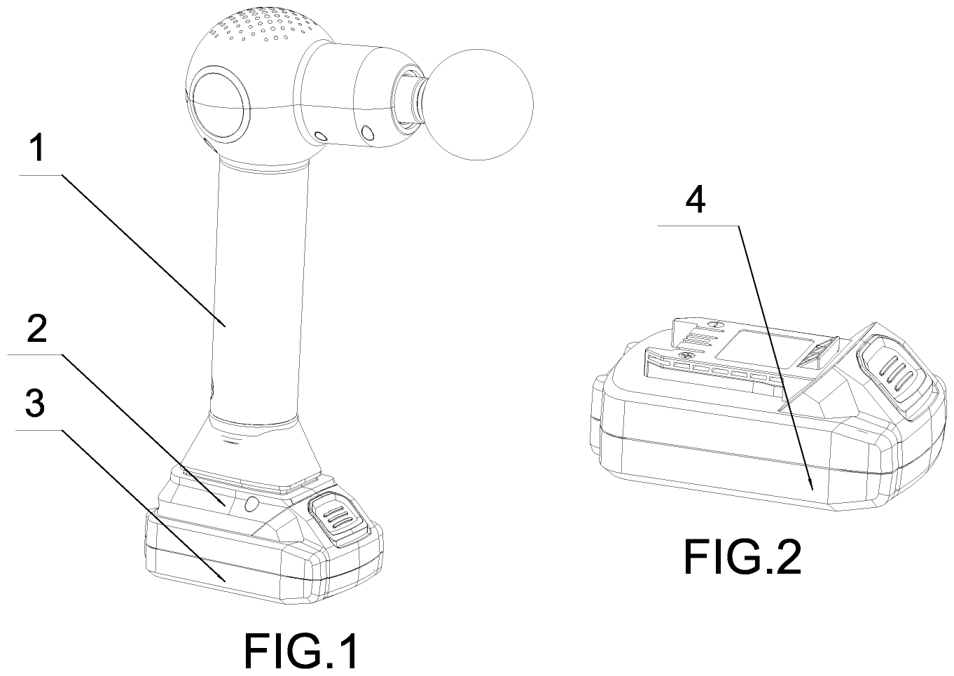

Referring to FIG. 1, a percussive massage gun in accordance with the invention comprises a handle 1, a battery assembly 3, and a connection member 2 integrally formed with the handle 1 and releasably secured to the battery assembly 3. The battery assembly 3 is implemented in first, second and third preferred embodiments as discussed in detail below.

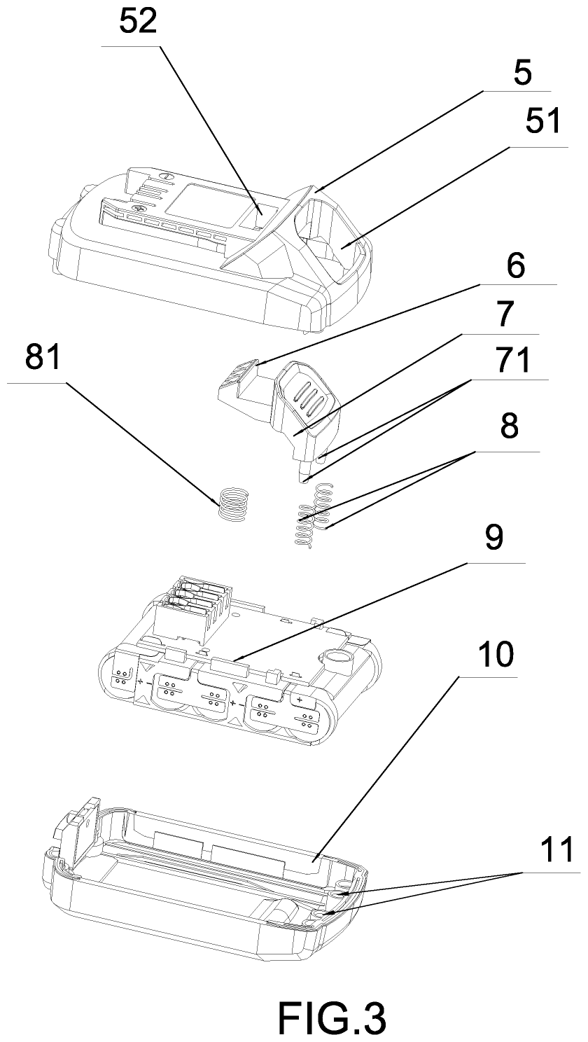

Referring to FIGS. 2 to 3, a first battery assembly 4 according to a first preferred embodiment of the invention comprises an upper shell 5, a lever 7, two torsion springs 8, a battery (e.g., rechargeable battery) 9 and a lower shell 10. The battery 9 is releasably fastened in the lower shell 10. The upper shell 5 includes a slot 52 and a through hole 51. The lever 7 is disposed through the through hole 51. A tab 6 is formed with the left side of the lever 7 and disposed through the slot 52. The lever 7 includes two downward extending pegs 71. The torsion springs 8 are put on the pegs 71. The lower shell 10 includes two bossed holes 11 for complementarily receiving the pegs 71. A compression spring 81 is biased between the tab 6 and the battery 9.

Assembled state of the first battery assembly 4 is detailed below.

The battery 9 is disposed in a plastic housing consisting of the upper shell 5 and the lower shell 10. Top of the upper shell 5 is releasably secured to the connection member 2 by sliding into two mating grooves (not shown) of the connection member 2. The tab 6 is further disposed in a mating slot (not shown) of the connection member 2. The compression spring 81 is biased between the tab 6 and the battery 9. The torsion springs 8 push the lever 7 through the through hole 51 to be positioned. As a result, the first battery assembly 4 is locked by the tab 6.

Release of the first battery assembly 4 is detailed below.

A sufficient pressing of the lever 7 by the finger compresses the compression spring 81 to disengage the tab 6 from the mating slot of the connection member 2 with the torsion springs 8 also compressed. As such, the first battery assembly 4 is released.

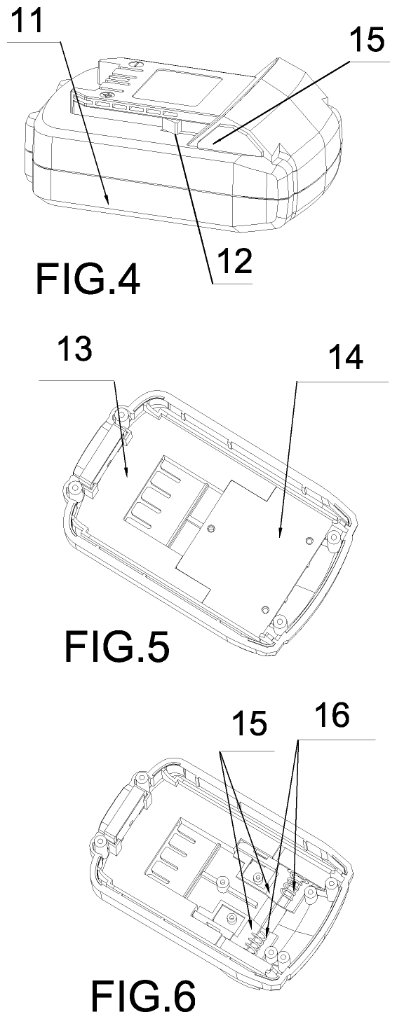

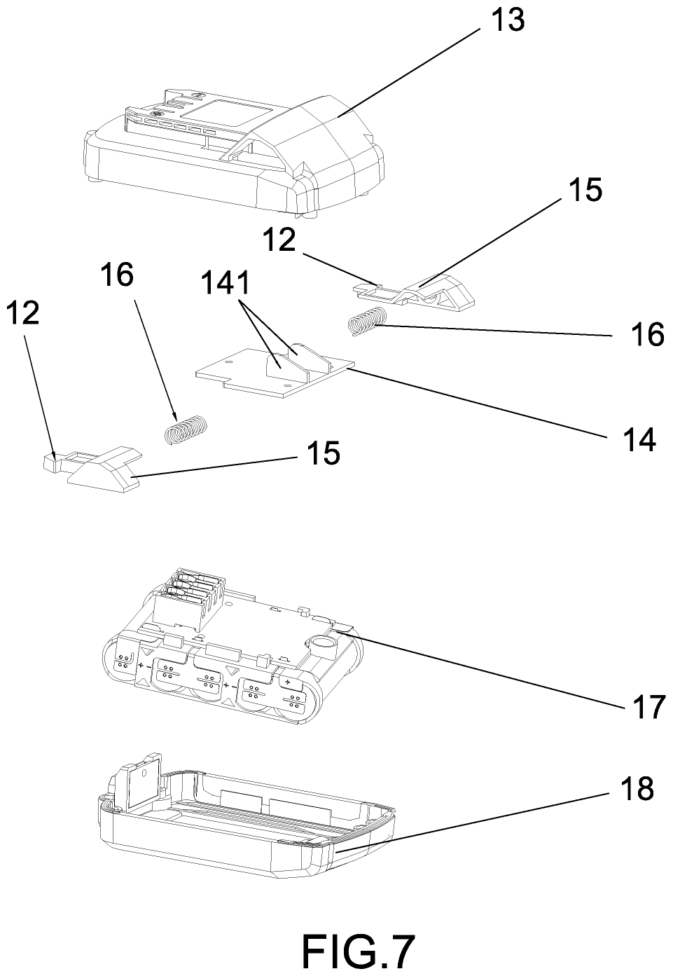

Referring to FIGS. 4 to 7, a second battery assembly 11 according to a second preferred embodiment of the invention comprises an upper shell 13, two levers 15, two compression springs 16, a plate 14 mounted on a bottom of the upper shell 13, a battery 17 and a lower shell 18. The upper shell 13 includes two internal grooves (not shown) with the levers 15 pivotably secured thereto. Two sides of the levers 15 are exposed. The plate 14 has two projecting members 141 each urging against one end of the compression spring 16. The other ends of the compression springs 16 urge against the levers 15 respectively. Two tabs 12 are (one is shown in FIG. 4) provided at one ends of the levers 15 respectively and exposed.

Assembled state of the second battery assembly 11 is detailed below.

The battery 17 is disposed in a plastic housing consisting of the upper shell 13 and the lower shell 18. The tabs 12 are locked in two cavities (not shown) of the connection member 2 respectively by the expanding compression springs 16. As a result, the second battery assembly 11 is locked.

Release of the second battery assembly 11 is detailed below.

A sufficient pressing of each side of the levers 15 by the fingers at the same time compresses the compression springs 16 to inwardly move the levers 15. And in turn, the tabs 12 are disengaged from the cavities of the connection member 2. As such, the second battery assembly 11 is released.

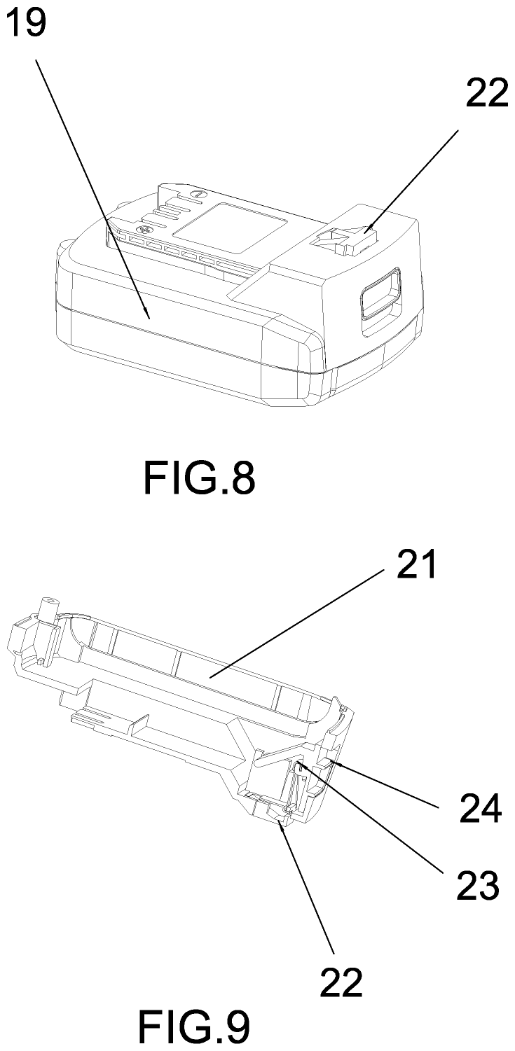

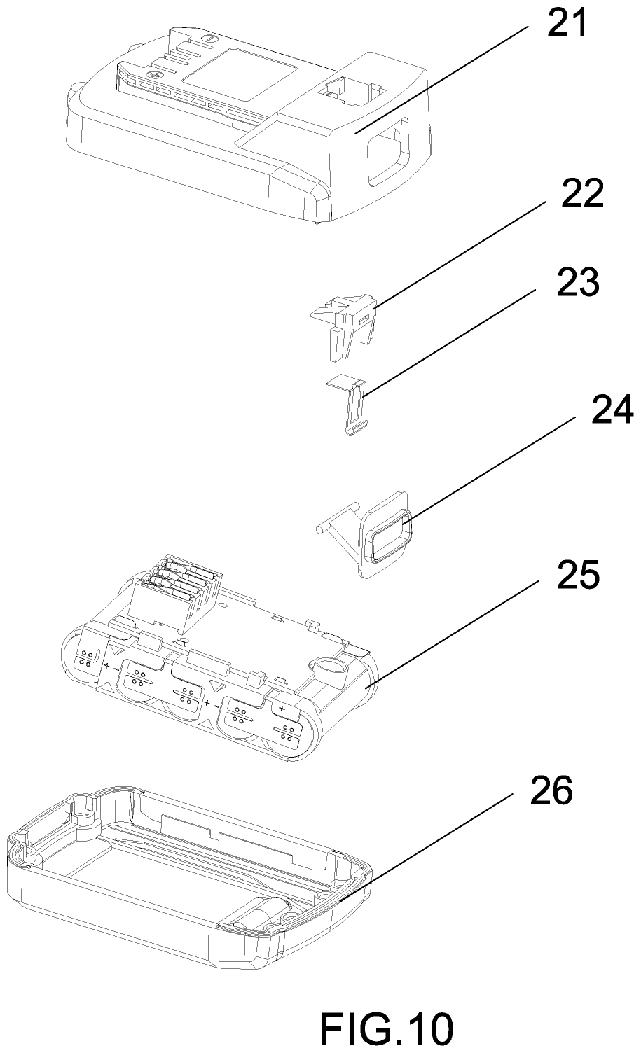

Referring to FIGS. 8 to 10, a third battery assembly 19 according to a third preferred embodiment of the invention comprises an upper shell 21, a button 22, an elastic member 23, a lever 24, a battery 25 and a lower shell 26. The upper shell 21 includes a longitudinal groove (not shown) on the right side with the button 22 pivotably secured thereto, and a transvers groove (not shown) on the right side with the lever 24 pivotably secured thereto. The elastic member 23 is fastened between the button 22 and the lever 24.

Assembled state of the third battery assembly 19 is detailed below.

The battery 25 is disposed in a plastic housing consisting of the upper shell 21 and the lower shell 26. Top of the upper shell 21 is releasably secured to the connection member 2 by sliding into two mating grooves (not shown) of the connection member 2. Thus, the button 22 is locked in a slot (not shown) of the connection member 2. As a result, the third battery assembly 19 is locked by the connection member 2.

Release of the third battery assembly 19 is detailed below.

A sufficient pressing of the lever 24 by the finger compresses the elastic member 23 which in turn pivots the button 22. Further, the button 22 disengages from the slot of the connection member 2. As such, the third battery assembly 19 is released.

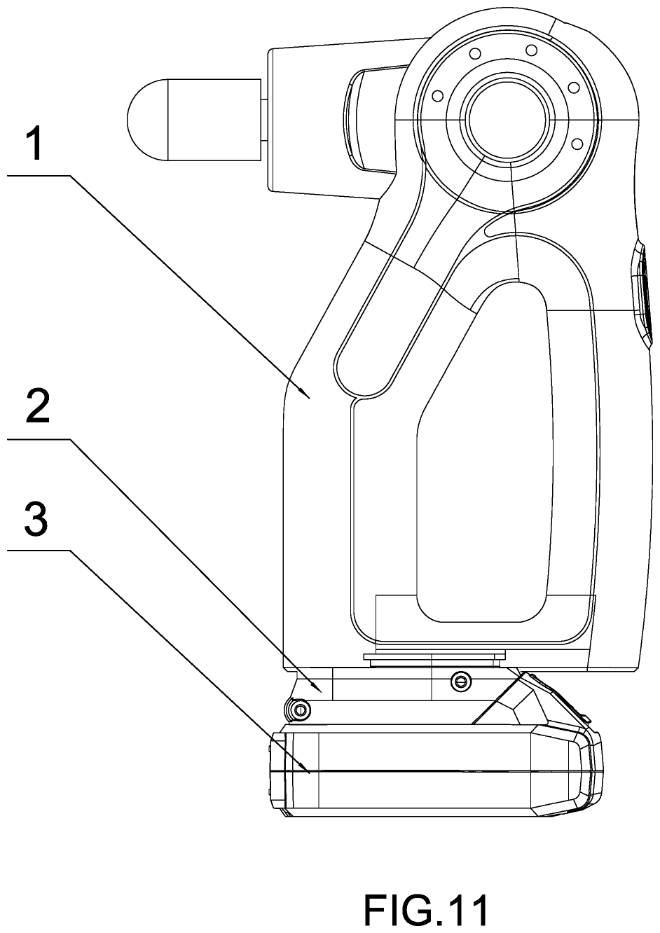

Referring to FIG. 11, it schematically depicts the handle 1, the connection member 2 and the battery assembly 3.

While the invention has been described in terms of preferred embodiments, those skilled in the art will recognize that the invention can be practiced with modifications within the spirit and scope of the appended claims.

What is claimed is:

1. A percussive massage gun comprising:
a handle;
a battery assembly including an upper shell, a lever, a tab formed with the lever, two first biasing members, a battery, a second biasing member biased between the tab and the battery, and a lower shell; and
a connection member formed with the handle and releasably secured to the battery assembly;
wherein the battery is releasably fastened in the upper and lower shells; the upper shell includes a slot with the lever disposed through, and a through hole; the lever includes two pegs; the first biasing members are put on the pegs to push the lever through the through hole to be positioned; and the lower shell includes two bossed holes for complementarily receiving the pegs.
